(19) United States
(12) Patent Application Publication
(10) Pub. No.: US 2019/0093746 A1
(43) Pub. Date: Mar. 28, 2019

(54) DYNAMIC DAMPER DEVICE

(71) Applicant: EXEDY Corporation, Osaka (JP)

(72) Inventor: Kousuke MURATA, Osaka (JP)

(73) Assignee: EXEDY Corporation

(21) Appl. No.: 16/116,059

(22) Filed: Aug. 29, 2018

(30) Foreign Application Priority Data
Sep. 22, 2017 (JP) 2017-182029
Jul. 30, 2018 (JP) 2018-142052

(51) Int. Cl. F16H 45/02; F16F 15/12; F16F 15/18; F16F 9/34; F16H 61/02

(52) U.S. Cl. CPC F16H 45/02; F16F 15/12; F16F 15/18; F16H 2045/0221; F16H 61/0251; F16H 2061/0253; F16H 2045/0273; F16F 9/34

(57) ABSTRACT

A dynamic damper device for inhibiting torque fluctuations in a rotor to which a torque is inputted includes a mass body and a magnetic damper mechanism. The mass body is disposed to be rotatable with the rotor and be rotatable relatively to the rotor. The magnetic damper mechanism includes at least a pair of magnets disposed in the rotor and the mass body. The magnetic damper mechanism couples the rotor and the mass body in a rotational direction by a magnetism of the pair of magnets.

### CROSS-REFERENCE TO RELATED APPLICATIONS

This application claims priority to Japanese Patent Application No. 2017-182029, filed Sep. 22, 2017, and Japanese Patent Application No. 2018-142052, filed Jul. 30, 2018. The contents of those applications are herein incorporated by reference in their entirety.

### BACKGROUND

### 1. Technical Field

The present disclosure relates to a dynamic damper device, particularly to a dynamic damper device for inhibiting torque fluctuations in a rotor to which a torque is inputted and that is rotated about a rotational axis.

### 2. Description of the Related Art

For example, a clutch device, including a damper device, and a torque converter are provided between an engine and a transmission in an automobile. Additionally, for reduction in fuel consumption, the torque converter is provided with a lock-up device for mechanically transmitting a torque at a predetermined rotational speed or greater.

In general, the lock-up device includes a clutch part and a damper including a plurality of torsion springs. In the lock-up device described above, torque fluctuations (fluctuations in rotational speed of an engine) are inhibited by the damper including the plural torsion springs.

Incidentally, a lock-up device described in Japan Laid-open Patent Application Publication No. 2009-293671 is provided with a dynamic damper device including an inertia member in order to inhibit torque fluctuations. The dynamic damper device described in Japan Laid-open Patent Application Publication No. 2009-293671 is provided with coil springs for elastically coupling an output plate and the inertia member in a rotational direction.

As described in Japan Laid-open Patent Application Publication No. 2009-293671, many of the well-known dynamic damper devices have a configuration that the output plate and the inertia member are coupled through the coil springs.

However, in use of the coil springs, a stopper mechanism is required to be provided for preventing the coil springs from being fully compressed in actuation. This results in a drawback that the dynamic damper device is complicated in structure and is also increased in size.

Additionally, there is a drawback that the stopper mechanism is frequently actuated by resonance of the dynamic damper device, whereby hitting sound is produced in actuation of the stopper mechanism.

### BRIEF SUMMARY

It is an object of the present disclosure to achieve simplification in structure and compactness in size of a dynamic damper device by abolishing a stopper mechanism, and in addition, to eliminate production of hitting sound in the dynamic damper device.

(1) A dynamic damper device according to the present disclosure is a device inhibiting torque fluctuations in a rotor to which a torque is inputted, and includes a mass body and a magnetic damper mechanism. The mass body is disposed to be rotatable with the rotor and be rotatable relatively to the rotor. The magnetic damper mechanism includes at least a pair of magnets disposed in the rotor and the mass body and couples the rotor and the mass body in a rotational direction by the magnetism of the pair of magnets.

In the present device, the rotor and the mass body are coupled in the rotational direction by the magnetism of the pair of magnets. Therefore, when a torque is inputted to the rotor, the rotor and the mass body are rotated. When the torque inputted to the rotor does not fluctuate, the relative displacement is not produced between the rotor and the mass body in the rotational direction. On the other hand, when the torque inputted to the rotor fluctuates, the relative displacement is produced between the mass body and the rotor in the rotational direction (the displacement will be hereinafter expressed as “rotational phase difference” on an as-needed basis) depending on the extent of torque fluctuations, because the mass body is disposed to be rotatable relatively to the rotor.

When the torque does not herein fluctuate, in other words, when the rotational phase difference is not produced between the rotor and the mass body, lines of magnetic force of the pair of magnets disposed in opposition to each other in the rotor and the mass body are in a stable condition. By contrast, when the rotational phase difference is produced between the rotor and the mass body, the lines of magnetic force generated by the pair of magnets are distorted, and are in an unstable condition. The lines of magnetic force in the unstable condition are going to restore to the stable condition, whereby the resilient force, by which the rotational phase difference between the rotor and the mass body becomes “0”, acts on the rotor and the mass body. In other words, the resilient force, acting on the rotor and the mass body, is similar to an elastic force of an elastic member such as a spring. The elastic force is exerted by the elastic member when the elastic member is elastically deformed, and serves to restore the deformed shape of the elastic member to the original shape thereof. Torque fluctuations are inhibited by this resilient force (elastic force).

The rotor and the mass body are herein magnetically coupled. Hence, the coil spring and the stopper mechanism, used so far in a well-known device, can be abolished, and simplification in structure and compactness in size of the device can be realized. Additionally, the stopper mechanism can be abolished, whereby it is possible to eliminate hitting sound produced so far in actuation of the stopper mechanism in the well-known device.

(2) Preferably, the magnetic damper mechanism includes a plurality of first magnets and a plurality of second magnets. The plurality of first magnets are attached to the rotor. The plurality of second magnets are attached to the mass body, while being opposed to the plurality of first magnets.

Here, the rotor and the mass body are magnetically coupled by the plurality of opposed pairs of first and second magnets. When the rotational phase difference is produced between the rotor and the mass body by torque fluctuations, lines of magnetic force between each pair of first and second magnets are turned into an unstable condition from a stable condition. Then, the lines of magnetic force are going to restore to the stable condition, whereby the resilient force (the force by which the rotational phase difference between the rotor and the mass body becomes “0”) acts on both. Consequently, torque fluctuations are inhibited.

(3) Preferably, the mass body, having an annular shape, is disposed on an outer peripheral side of the rotor and is opposed at an inner peripheral surface thereof to an outer peripheral surface of the rotor. Additionally, the plurality of first magnets are disposed in an outer peripheral part of the rotor, and the plurality of second magnets are disposed in an inner peripheral part of the mass body.

Here, the mass body is disposed on the outer peripheral side of the rotor, while the plurality of first magnets and the plurality of second magnets are disposed in radial opposition to each other. Therefore, increase in axial space of the dynamic damper device can be inhibited.

(4) Preferably, the plurality of first magnets are disposed in the outer peripheral part of the rotor in a circular alignment, whereas the plurality of second magnets are disposed in the inner peripheral part of the mass body in a circular alignment. Additionally, the magnetic damper mechanism further includes flux barriers provided circumferentially between adjacent two of the plurality of first magnets and circumferentially between adjacent two of the plurality of second magnets, respectively.

Here, each flux barrier is provided between adjacent two of the magnets. Hence, the roundabout flow of magnetic flux can be prevented at each magnet, and it is possible to strengthen, for example, a pull force between magnets or the resilient force acting on the rotor and the mass body as much as possible.

It should be noted that the flux barriers can be made of gaps or non-magnetic material such as resin.

(5) Preferably, the plurality of first magnets are disposed such that polarities thereof are aligned circumferentially and alternately, whereas the plurality of second magnets are disposed such that polarities thereof are aligned circumferentially and alternately.

(6) Preferably, at least one of the rotor and the mass body is axially divided into at least two parts. In this case, the divided parts of the rotor or mass body are insulated from each other, whereby it is possible to reduce eddy current to be generated by time-series variation of the magnetic flux passing through the interior of the rotor or mass body.

(7) Preferably, the magnetic damper mechanism further includes insulators provided on a boundary surface between the divided parts of the rotor and a boundary surface between the divided parts of the mass body.

When the insulators are provided on the boundary surface of the divided parts of the rotor or mass body, it is possible to further reduce eddy current to be generated in the rotor or mass body. Therefore, it is possible to inhibit heat generation in the respective members and reduce a hysteresis torque appearing in torsional characteristics.

(8) Preferably, the at least one of first and second magnets is divided into at least two parts, and the at least two parts are opposed to each of the plurality of the other second or first magnets.

When the plurality of first or second magnets are each divided, initial distortion of the lines of magnetic force occurs in the stable condition of the lines of magnetic force, i.e., a condition without rotational phase difference between the rotor and the mass body. Due to the initial distortion, a preliminary resilient force acts between the rotor and the mass body even in the condition without rotational phase difference. With the preliminary resilient force described above, a torque can be increased in magnitude with respect to a torsion angle in a low torsion angular range, whereby the torsional stiffness can be enhanced.

(9) Preferably, the dynamic damper device further includes a moving mechanism axially moving either the rotor or the mass body.

The effective thickness of the magnetic damper mechanism is changed by axially moving either the rotor or the mass body.

Here, “the effective thickness of the magnetic damper mechanism” refers to the axial length of a region in which the rotor and the mass body axially overlap as seen in a direction arranged orthogonally to a rotational axis.

With change in effective thickness of the magnetic damper mechanism, the torsional stiffness of the dynamic damper device can be arbitrarily set. For example, with reduction in effective thickness of the magnetic damper mechanism, it is possible to reduce a magnetic coupling force between the rotor and the mass body, i.e., an elastic force. Accordingly, the torsional stiffness can be reduced as done by setting low the torsional stiffness of each coil spring in the well-known dynamic damper device.

(10) Preferably, the torque inputted to the rotor is from an engine. In this case, the dynamic damper device preferably further includes a drive mechanism for driving the moving mechanism and a moving control part controlling the drive mechanism in accordance with at least a rotational speed of the engine.

(11) Preferably, the moving mechanism includes a piston that is axially movable together with either the rotor or the mass body. The drive mechanism is preferably a hydraulic control valve driving the piston by a hydraulic pressure from a hydraulic source. The moving control part preferably outputs a hydraulic control signal to the hydraulic control valve.

(12) Preferably, the magnetic damper mechanism couples the rotor and the mass body in a rotational direction by the pull force of the pair of magnets.

(13) A power transmission device according to the present disclosure includes the rotor to which the torque is inputted, the mass body and the magnetic damper mechanism. The mass body is disposed to be rotatable with the rotor and be rotatable relatively to the rotor. The magnetic damper mechanism includes at least a pair of magnets disposed in the rotor and the mass body and couples the rotor and the mass body in a rotational direction.

Overall, according to the present advancement described above, a stopper mechanism can be abolished in a dynamic damper device, and simplification in structure and compactness in size of the dynamic damper device can be achieved. Additionally, it is possible to eliminate hitting sound produced so far in actuation of the stopper mechanism in a well-known dynamic damper device.

### BRIEF DESCRIPTION OF THE DRAWINGS

FIG. 1 is a cross-sectional configuration view of a power transmission device including a dynamic damper device according to a first preferred embodiment of the present disclosure.

FIG. 2 is a front view of a hub, an inertia member and a magnetic damper mechanism in the power transmission device shown in FIG. 1.

FIG. 3 is a diagram showing a magnetic field when a torsion angle of the magnetic damper mechanism is 0 degrees.

FIG. 4 is a diagram showing a magnetic field when the torsion angle of the magnetic damper mechanism is 10 degrees.

FIG. 5 is a torsional characteristic diagram of the first preferred embodiment and modifications 1 and 2.

FIG. 6 is a diagram according to the modification 1 and corresponds to FIG. 2.

FIG. 7 is a diagram according to the modification 2 and corresponds to FIG. 2.

FIG. 8 is a diagram according to the modification 3 and corresponds to FIG. 2.

FIG. 9A is a diagram according to a second preferred embodiment of the present disclosure and corresponds to FIG. 1.

FIG. 9B is a diagram of a condition made after actuation of a moving mechanism according to the second preferred embodiment of the present disclosure.

FIG. 10 is a control block diagram according to the second preferred embodiment.

FIG. 11 is a control flow chart according to the second preferred embodiment.

FIG. 12 is a diagram showing an application example of the dynamic damper device of the present disclosure.

FIG. 13 is a view of a hub and an inertia member according to another preferred embodiment.

### DETAILED DESCRIPTION OF THE PREFERRED EMBODIMENTS

### First Preferred Embodiment

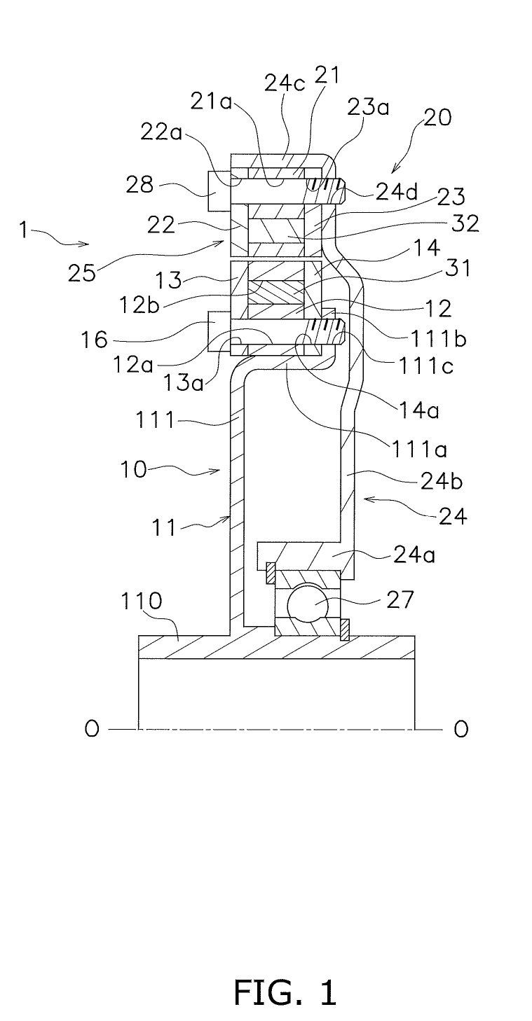

FIG. 1 is a cross-sectional view of a power transmission device including a dynamic damper device according to a first preferred embodiment of the present disclosure. In FIG. 1, line O-O indicates a rotational axis.

[Entire Configuration]

A power transmission device 1 includes a rotor 10, to which a torque is inputted, and a dynamic damper device 20 for inhibiting fluctuations in torque inputted to the rotor 10. The rotor 10 is, for instance, an output-side rotor of a lock-up device of a torque converter. In this case, the torque is inputted to the rotor 10 from a front cover through a clutch part and a damper mechanism. The torque, inputted to the rotor 10, is then transmitted to a transmission-side input shaft. Additionally, the torque is inputted to the rotor 10 from a turbine of the torque converter as well.

[Rotor 10]

The rotor 10 includes a body 11, a hub 12 and a pair of inner peripheral side plates 13 and 14.

The body 11 includes an inner peripheral cylindrical portion 110 and a disc portion 111. The inner peripheral cylindrical portion 110 has an axially extending shape and the center axis thereof is matched with the rotational axis. When used as the output-side rotor of the lock-up device, the rotor 10 is provided with a spline hole in the interior thereof. Additionally, the input shaft of the transmission is engaged with the spline hole. The disc portion 111 includes a radial support portion 111a in the outer peripheral part thereof. The radial support portion 111a is made in the shape of a tube extending in the axial direction. Additionally, the distal end of the radial support portion 111a is bent to extend radially outward, and is provided as an axial support portion 111b. The axial support portion 111b is provided with screw holes 111c axially penetrating therethrough.

The hub 12 has an annular shape, and is supported by the outer peripheral surface of the radial support portion 111a of the disc portion 111. The hub 12 is made of soft magnetic material such as iron. The hub 12 is provided with holes 12a axially penetrating the inner peripheral part thereof.

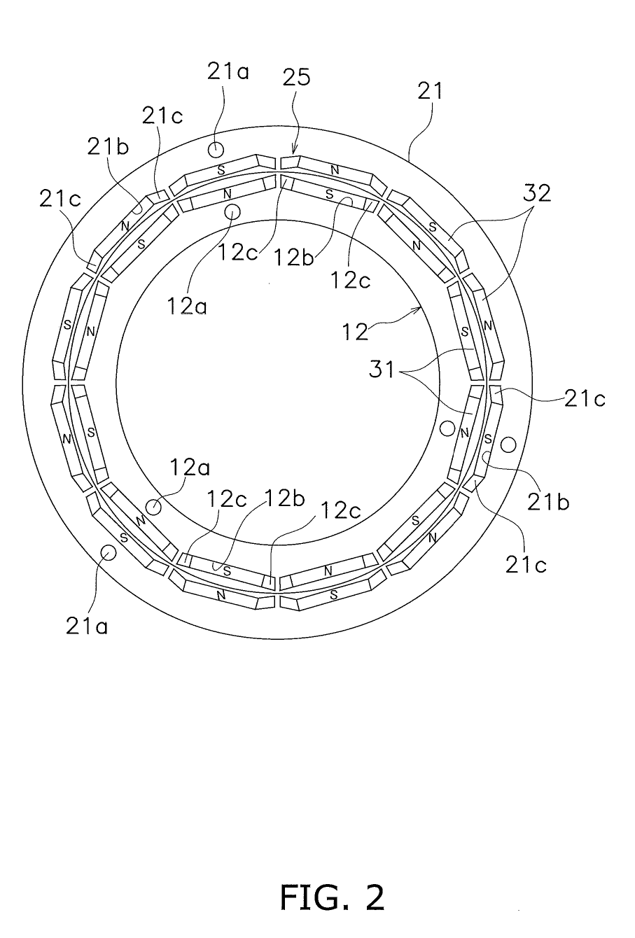

Additionally, as shown in FIG. 2, the hub 12 is provided with a plurality of first accommodation portions 12b and a plurality of first flux barriers 12c on the outer peripheral side of the holes 12a. It should be noted that FIG. 2 only shows the hub 12, an inertia member 21 (to be described) and magnets 31 and 32 accommodated in the hub 12 and the inertia member 21, while the other members are removed therefrom.

Each first accommodation portion 12b is an opening that has a rectangular shape as seen in a front view and has a predetermined thickness in the radial direction. Additionally, each first accommodation portion 12b axially penetrates the hub 12. Also, the first accommodation portions 12b are disposed in circular alignment. One pair of first flux barriers 12c is provided on both circumferential ends of each first accommodation portion 12b. It should be noted that each first accommodation portion 12b and each pair of first flux barriers 12c are continuously provided, and compose a single opening axially penetrating the hub 12. In other words, the first flux barriers 12c are herein gaps. It should be noted that non-magnetic material such as resin can be attached, as the first flux barriers 12c, to the first accommodation portions 12b.

The pair of inner peripheral side plates 13 and 14 is made of non-magnetic material such as aluminum, and is disposed axially on both sides of the hub 12. In other words, the pair of inner peripheral side plates 13 and 14 is disposed to interpose the hub 12 axially therebetween. Each of the pair of inner peripheral side plates 13 and 14 is provided with holes 13a, 14a axially penetrating the inner peripheral part thereof. Both the holes 13a and the holes 14a are disposed in corresponding positions to the holes 12a of the hub 12.

Additionally, the hub 12 and the pair of inner peripheral side plates 13 and 14 are fixed by bolts 16 penetrating triads of holes 12a, 13a and 14a, respectively. In more detail, the bolts 16 are screwed into the screw holes 111c of the axial support portion 111b, whereby the hub 12 and the pair of inner peripheral side plates 13 and 14 are fixed to the axial support portion 111b.

With the configuration described above, a unit, composed of the hub 12 and the pair of inner peripheral side plates 13 and 14, is radially positioned by the radial support portion 111a of the body 11, while being axially positioned by the axial support portion 111b.

[Dynamic Damper Device 20]

The dynamic damper device 20 is a device for inhibiting fluctuations in torque inputted to the rotor 10. The dynamic damper device 20 includes the inertia member 21 provided as a mass body, a pair of outer peripheral side plates 22 and 23, a support member 24 and a magnetic damper mechanism 25.

<Inertia Member 21 and Pair of Outer Peripheral Side Plates 22 and 23>

The inertia member 21 has an annular shape and is disposed radially outside the hub 12 so as to be radially opposed to the hub 12. In other words, the inner peripheral surface of the inertia member 21 and the outer peripheral surface of the hub 12 are radially opposed at a predetermined gap. Similarly to the hub 12, the inertia member 21 is made of soft magnetic material such as iron. The inertia member 21 is provided with holes 21a axially penetrating the outer peripheral part thereof.

Additionally, as shown in FIG. 2, the inertia member 21 is provided with a plurality of second accommodation portions 21b and a plurality of second flux barriers 21c on the inner peripheral side of the holes 21a.

Each second accommodation portion 21b is an opening that has a rectangular shape as seen in a front view and has a predetermined thickness in the radial direction. Additionally, each second accommodation portion 21b axially penetrates the inertia member 21. Also, the second accommodation portions 21b are disposed in circular alignment, while being radially opposed to the first accommodation portions 12b, respectively. One pair of second flux barriers 21c is provided on both circumferential ends of each second accommodation portion 21b. The second flux barriers 21c are openings axially penetrating the inertia member 21. In other words, the second flux barriers 21c are herein gaps. It should be noted that non-magnetic material such as resin can be attached, as the second flux barriers 21c, to the second accommodation portions 21b. One pair of second flux barriers 21c is provided to continue to each second accommodation portion 21b, and each is shaped to slant radially inward with separation from the boundary thereof against each second accommodation portion 21b.

The pair of outer peripheral side plates 22 and 23 is made of non-magnetic material such as aluminum, and is disposed axially on both sides of the inertia member 21. In other words, the pair of outer peripheral side plates 22 and 23 is disposed to interpose the inertia member 21 axially therebetween. Each of the pair of outer peripheral side plates 22 and 23 is provided with holes 22a, 23a axially penetrating the outer peripheral part thereof. Both the holes 22a and the holes 23a are disposed in corresponding positions to the holes 21a of the inertia member 21.

<Support Member 24>

The support member 24 is rotatably supported by the rotor 10 through a bearing 27. In more detail, the support member 24 is rotatably supported by the inner peripheral cylindrical portion 110 of the rotor 10 through the bearing 27. The support member 24 includes an inner peripheral support portion 24a, a disc portion 24b and an outer peripheral support portion 24c.

The inner peripheral support portion 24a is made in the shape of a tube that the bearing 27 is attached to the inner peripheral part thereof. The disc portion 24b extends radially outward from one end of the inner peripheral support portion 24a. The outer peripheral support portion 24c is made in the shape of a tube that axially extends from the outer peripheral part of the disc portion 24b. Additionally, the inertia member 21 and the pair of outer peripheral side plates 22 and 23 are fixed to the inner peripheral surface of the outer peripheral support portion 24c. In more detail, the disc portion 24b is provided with screw holes 24d in the outer peripheral part thereof. Bolts 28 are screwed into the screw holes 24d, respectively, while penetrating triads of holes 21a, 22a and 23a, respectively. Accordingly, the inertia member 21 and the pair of outer peripheral side plates 22 and 23 are fixed to the support member 24.

With the configuration described above, a unit, composed of the hub 21 and the pair of outer peripheral side plates 22 and 23, is radially positioned by the outer peripheral support portion 24c of the support member 24, while being axially positioned by the disc portion 24b of the support member 24.

<Magnetic Damper Mechanism 25>

The magnetic damper mechanism 25 is a mechanism that magnetically couples the inertia member 21 and the rotor 10 (the member of which the magnetic damper mechanism 25 acts on is the hub 12, directly speaking, and will be hereinafter simply referred to as “the hub 12”) and generates a resilience force when relative displacement is produced between the hub 12 and the inertia member 21 in a rotational direction in order to reduce the relative displacement. It should be noted that “magnetically coupling” means coupling the hub 12 and the inertia member 21 in the rotational direction by the magnetism.

The magnetic damper mechanism 25 includes a plurality of first magnets 31 and a plurality of second magnets 32. The plural first magnets 31 are disposed in the first accommodation portions 12b of the hub 12, respectively. Additionally, the plural second magnets 32 are disposed in the second accommodation portions 21b of the inertia member 21, respectively. Therefore, the first magnets 31 and the second magnets 32 are disposed in radial opposition to each other.

The first and second magnets 31 and 32 are permanent magnets formed by neodymium sintered magnets or so forth. As shown in FIG. 2, each opposed pair of first and second magnets 31 and 32 is disposed to have opposite polarities N and S so as to generate a pull force therebetween. Additionally, both the plural first magnets 31 and the plural second magnets 32 are disposed such that the polarities N and S are aligned circumferentially and alternately.

[Actuation of Magnetic Damper Mechanism 25]

In the present preferred embodiment, a torque is inputted to the rotor 10 from a drive source such as an engine (not shown in the drawings). For example, when the power transmission device 1 is used for a lock-up device of a torque converter, in a lock-up on state, a torque transmitted to a front cover is transmitted to the rotor 10 through an input-side rotor and a damper including torsion springs.

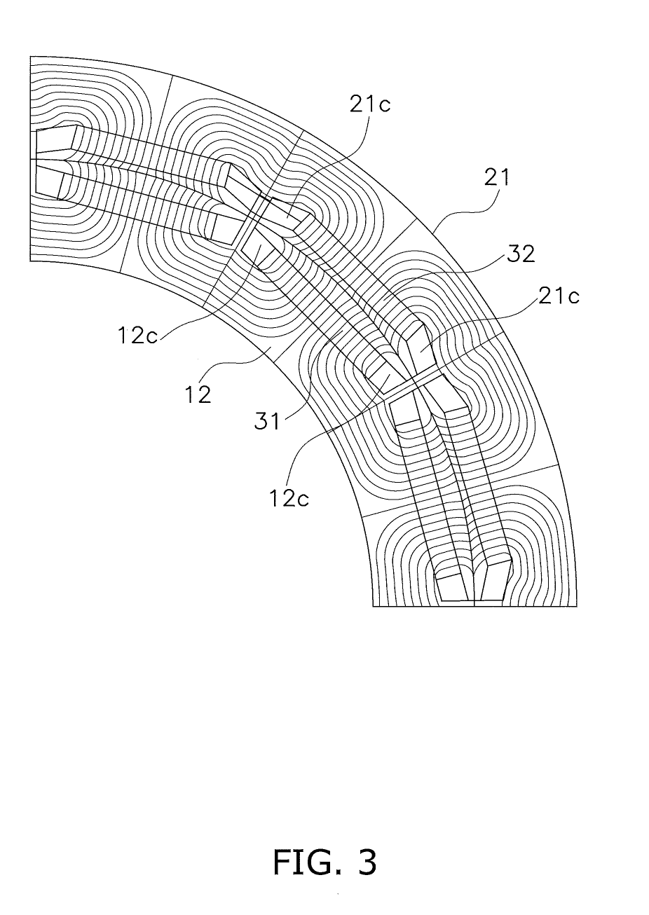

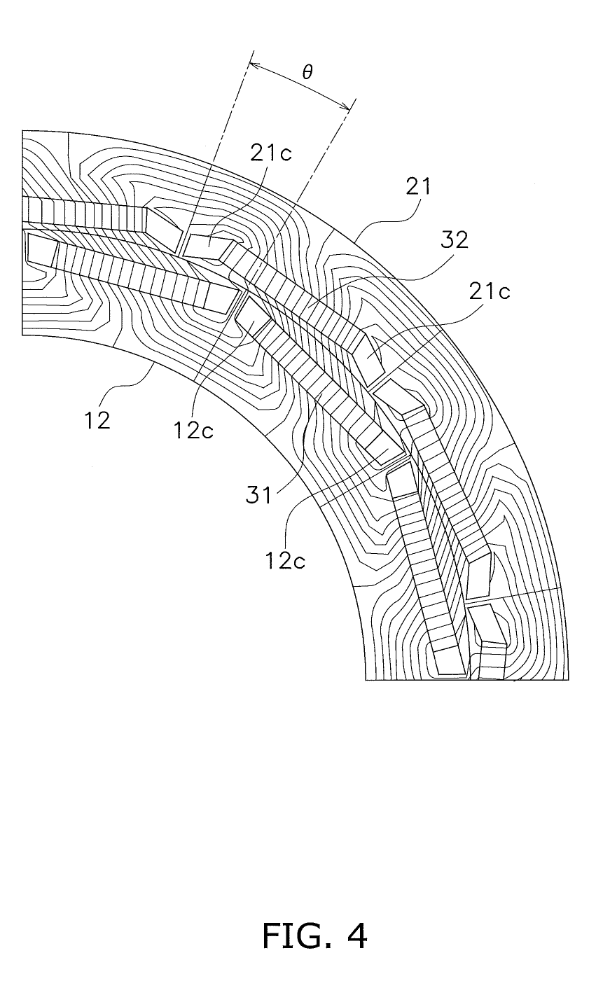

FIGS. 3 and 4 are magnetic field diagrams showing lines of magnetic force between the first magnets 31 and the second magnets 32. It should be noted that in FIGS. 3 and 4, radially extending straight lines are depicted between circumferentially adjacent pairs of first and second magnets 31 and 32 for convenience and easy understanding of the rotational phase difference between the hub 12 and the inertia member 21 and a condition of lines of magnetic force. Hence, the radially extending straight lines are not depicted as lines of magnetic force. Additionally, circumferential division between the hub 12 and the inertia member 21 is not indicated by the radially extending straight lines.

When torque fluctuations do not exist in torque transmission, the hub 12 and the inertia member 21 are rotated in the condition shown in FIG. 3. In other words, the hub 12 and the inertia member 21 are rotated without relative displacement in the rotational direction (i.e., in a condition that the rotational phase difference is “0”), because the hub 12 and the inertia member 21 are magnetically coupled by the pull forces of the first and second magnets 31 and 32 provided in both members 12 and 21.

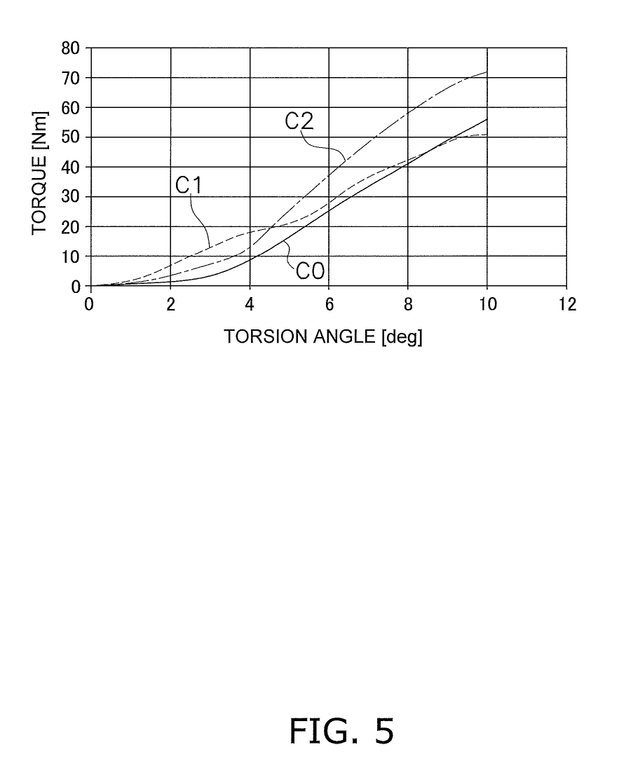

In such a condition that the polarity N of the first magnet 31 and the polarity S of the second magnet 32 are opposed in each pair of first and second magnets 31 and 32 without being displaced in the rotational direction, lines of magnetic force generated by the first and second magnets 31 and 32 are in the most stable condition. This condition corresponds to the origin (where torsion angle is 0 degrees) in the torsional characteristic diagram of FIG. 5.

On the other hand, when torque fluctuations exist in torque transmission, a rotational phase difference 0 (of 10 degrees in this example) is produced between the hub 12 and the inertia member 21 as shown in FIG. 4. In this condition, lines of magnetic force generated by the first and second magnets 31 and 32 are distorted, and are in an unstable condition. The lines of magnetic force in the unstable condition are going to restore to the stable condition as shown in FIG. 3, whereby a resilient force is generated. In other words, the resilient force is generated to make the rotational phase difference between the hub 12 and the inertia member 21 “0”. The resilient force corresponds to an elastic force in a heretofore known damper mechanism using torsion springs.

As described above, when the rotational phase difference is produced between the hub 12 and the inertia member 21 by torque fluctuations, the hub 12 receives the resilient force that is attributed to the first and second magnets 31 and 32 and is directed to reduce the rotational phase difference between both members 12 and 21. Torque fluctuations are inhibited by this force.

The aforementioned force for inhibiting torque fluctuations varies in accordance with the rotational phase difference between the hub 12 and the inertia member 21, whereby torsional characteristic C0 can be obtained as shown in FIG. 5.

[Modifications 1, 2 and 3]

In the example of FIG. 2, the second magnets 32 are disposed in opposition to the first magnets 31 on a one-to-one basis. However, one of each pair of first and second magnets 31 and 32 can be divided.

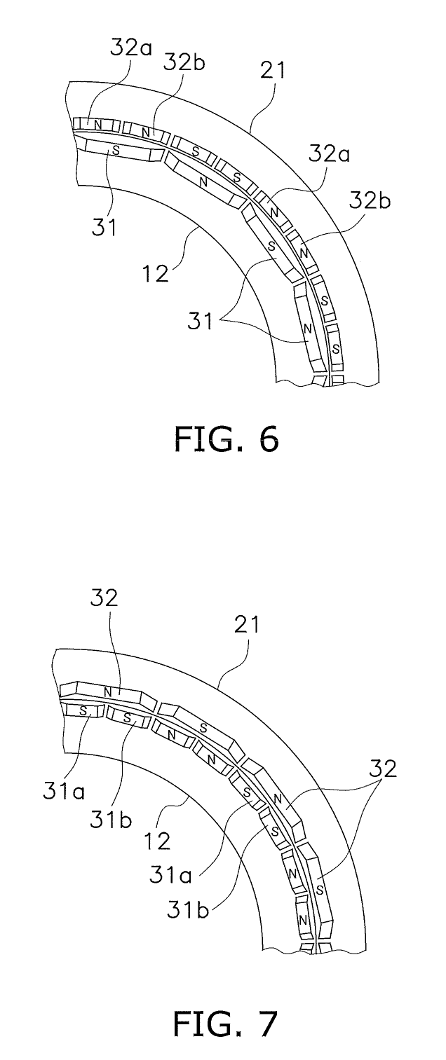

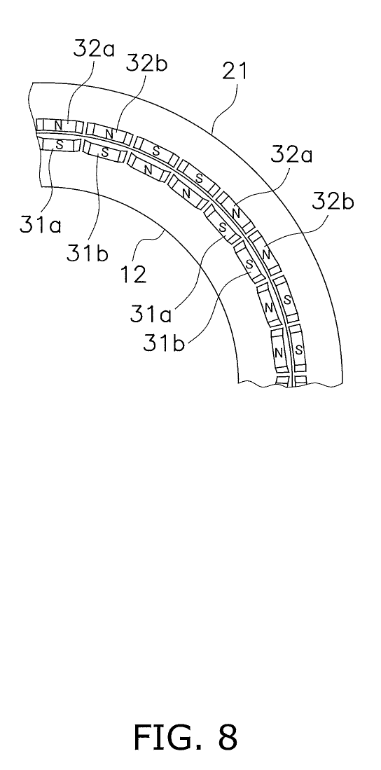

For example, in modification 1 shown in FIG. 6, two second magnets 32a and 32b are disposed in opposition to one first magnet 31. On the other hand, in modification 2 shown in FIG. 7, one second magnet 32 is disposed in opposition to two first magnets 31a and 31b.

According to these examples shown in FIGS. 6 and 7, in the stable condition as shown in FIG. 3, in other words, in the condition without rotational phase difference between the hub 12 and the inertia member 21, initial distortion is supposed to be caused in lines of magnetic force. A preliminary resilient force (a resilient force generated in the stable condition) is generated by this initial distortion. Therefore, torsional stiffness can be enhanced. For example, as shown in FIG. 5, the value of torque to torsion angle can be enhanced from characteristic C0 to characteristic C1 in a low torsion angular range of 0 to 4 degrees. It should be noted that in the torsional characteristics of modifications 1 and 2, the value of torque is “0” at a torsion angle of 0 degrees. This is because initial distortions (preliminary resilience forces) of the divided magnets are directed oppositely, and are thereby canceled out.

FIG. 5 shows torsional characteristics of the examples shown in FIGS. 2, 6 and 7. Characteristic C0 indicates the characteristic of the example shown in FIG. 2; characteristic C1 indicates the characteristic of modification 1 shown in FIG. 6; and characteristic C2 indicates the characteristic of modification 2 shown in FIG. 7.

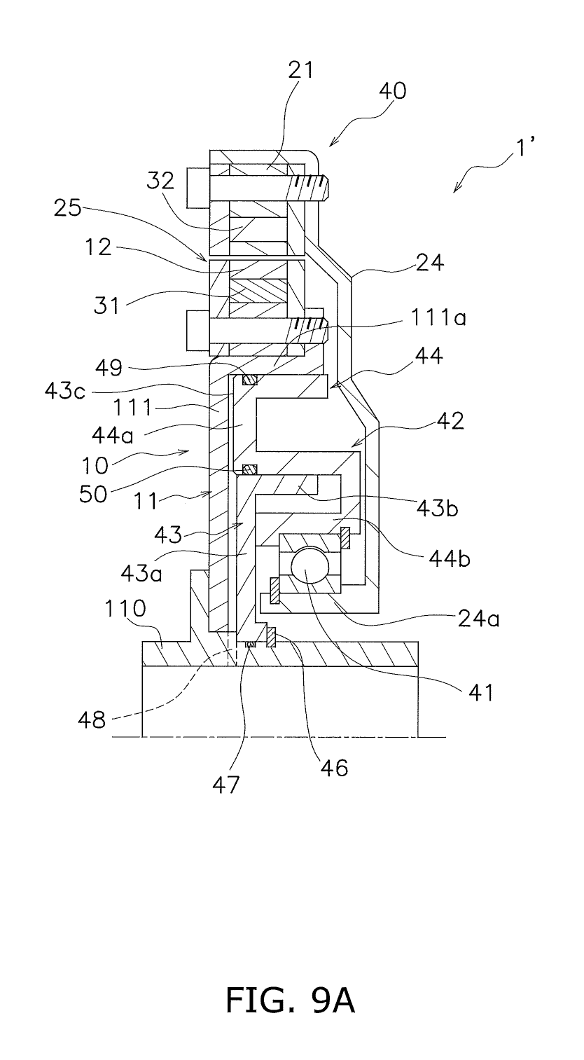

Furthermore, as shown in FIG. 8, both of the first magnets 31 and the second magnets 32 can be divided and disposed in opposition to on a one-to-one basis. In the example of FIG. 8, two first magnets 31a and 31b with the polarities S are opposed in each pair of two second magnets 32a and 32b with the polarities N. Additionally, in the hub 12 and the inertia member 21, a set of two magnets with the same polarities are disposed to be aligned alternately in the circumferential direction, such as two magnets 31a and 31b with the polarities S (32a, 32b)→two magnets 31a and 31b with the polarities N (32a, 32b)→two magnets 31a and 31b with the polarities S (32a, 32b).

### Second Preferred Embodiment

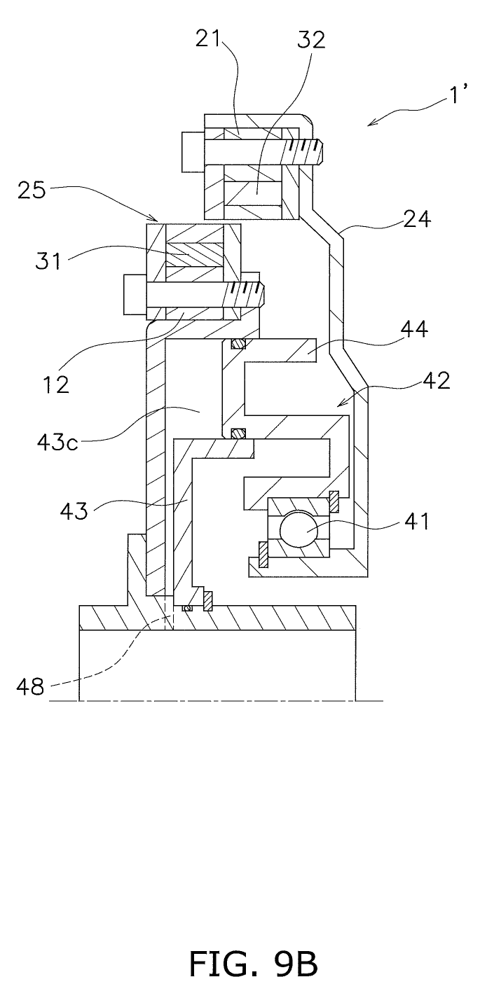

FIGS. 9A and 9B show a power transmission device 1′ including a dynamic damper device 40 according to a second preferred embodiment. The second preferred embodiment will be hereinafter explained. In the second preferred embodiment, when a given constituent element is similar to or corresponds to a comparative one in the first preferred embodiment, a reference sign assigned to the comparative one will be similarly assigned to the given constituent element, and explanation of the given constituent element will be omitted.

The dynamic damper device 40 according to the second preferred embodiment includes an effective thickness variable mechanism (moving mechanism) 42 that axially moves the inertia member 21 with respect to the hub 12. The effective thickness variable mechanism 42 includes an oil chamber forming member 43 and a piston 44.

The oil chamber forming member 43 is disposed in axial opposition to the inner peripheral part of the body 11 of the rotor 10. The oil chamber forming member 43 includes a disc portion 43a and a tubular portion 43b.

The disc portion 43a is fixed at the inner peripheral part thereof to the outer peripheral surface of the inner peripheral cylindrical portion 110 of the rotor 10. In more detail, the inner peripheral cylindrical portion 110 is provided with a step portion and includes a snap ring 46 attached to the outer peripheral surface thereof. The oil chamber forming member 43 is fixed by this step portion and the snap ring 46, while being axially immovable. It should be noted that a seal member 47 is disposed between the inner peripheral surface of the disc portion 43a and the outer peripheral surface of the inner peripheral cylindrical portion 110.

The tubular portion 43b axially extends from the outer peripheral part of the disc portion 43a. A cylinder part 43c, which is an annular space, is formed between the tubular portion 43b and the radial support portion 111a of the rotor 10. It should be noted that the inner peripheral cylindrical portion 110 of the rotor 10 is provided with an oil pathway 48 for introducing the hydraulic oil to the cylinder part 43c.

The piston 44 is disposed axially between the rotor 10 and the support member 24, while being axially movable. The piston 44 includes a body 44a and a support portion 44b.

The body 44a has an annular shape and includes a space in the interior thereof. The body 44a is attached to the cylinder part 43c, while being axially slidable. Seal members 49 and 50 are disposed on the outer and inner peripheral surfaces of the body 44a, respectively, so as to be disposed between the body 44a and the cylinder part 43c.

The support portion 44b is provided further radially inside the body 44a. The support portion 44b is made in the shape of a tube extending in the axial direction, and a bearing 41 is attached to the inner peripheral surface of the support portion 44b and the outer peripheral surface of the inner peripheral support portion 24a of the support member 24. In other words, the support member 24 is rotatably supported by the support portion 44b of the piston 44 through the bearing 41.

In the second preferred embodiment described above, when the hydraulic oil is introduced to the cylinder part 43c through the oil pathway 48, the inertia member 21 supported by the support member 24 can be axially moved. For example, as shown in FIG. 9B, when the inertia member 21 is moved to the right side of FIG. 9B with respect to the hub 12, the magnetic damper mechanism 25 can be reduced in effective thickness (that refers to, as described above, the axial length of a region in which the hub 12 and the inertia member 21 axially overlap as seen in a direction arranged orthogonally to the axis). With reduction in effective thickness, it is possible to reduce the magnetic coupling force between the hub 12 and the inertia member 21, i.e. the elastic force (the resilient force). Therefore, the dynamic damper device can be reduced in torsional stiffness. Specifically, the slope of the characteristic shown in FIG. 5 can be made as gentle as possible.

As described above, with the effective thickness variable mechanism 42 being provided, the effective thickness of the magnetic damper mechanism 25 can be changed, and the torsional stiffness of the dynamic damper device can be set to an arbitrary characteristic.

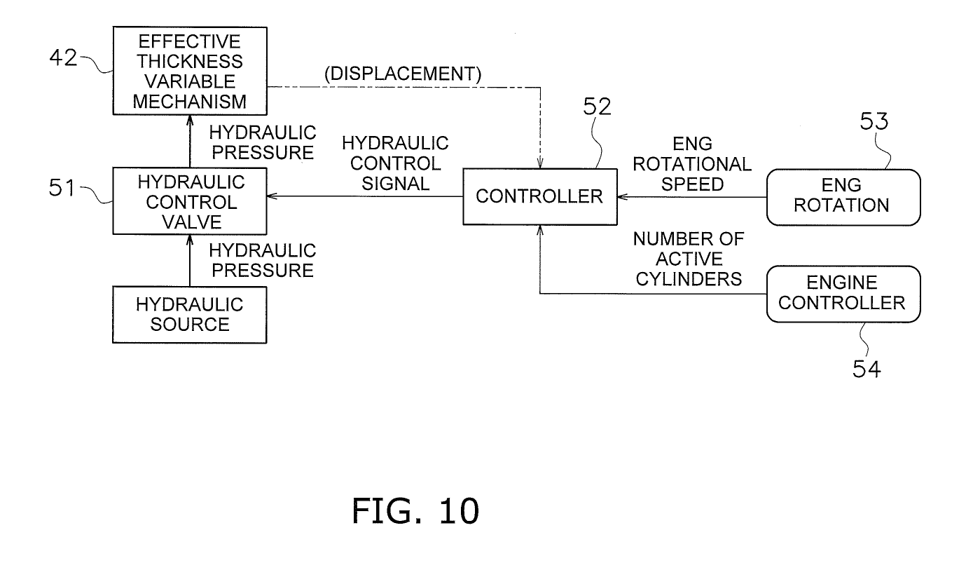

FIG. 10 shows a control block diagram of the effective thickness variable mechanism 42. A hydraulic control valve 51, provided as a drive mechanism, is connected to the effective thickness variable mechanism 42. Hydraulic pressure is supplied to the hydraulic control valve 51 from a hydraulic source such as an oil pump. Additionally, the hydraulic control valve 51 is controlled by a hydraulic control signal from a controller 52, whereby the hydraulic pressure controlled by the hydraulic control valve 51 is supplied to the oil pathway 48 of the effective thickness variable mechanism 42.

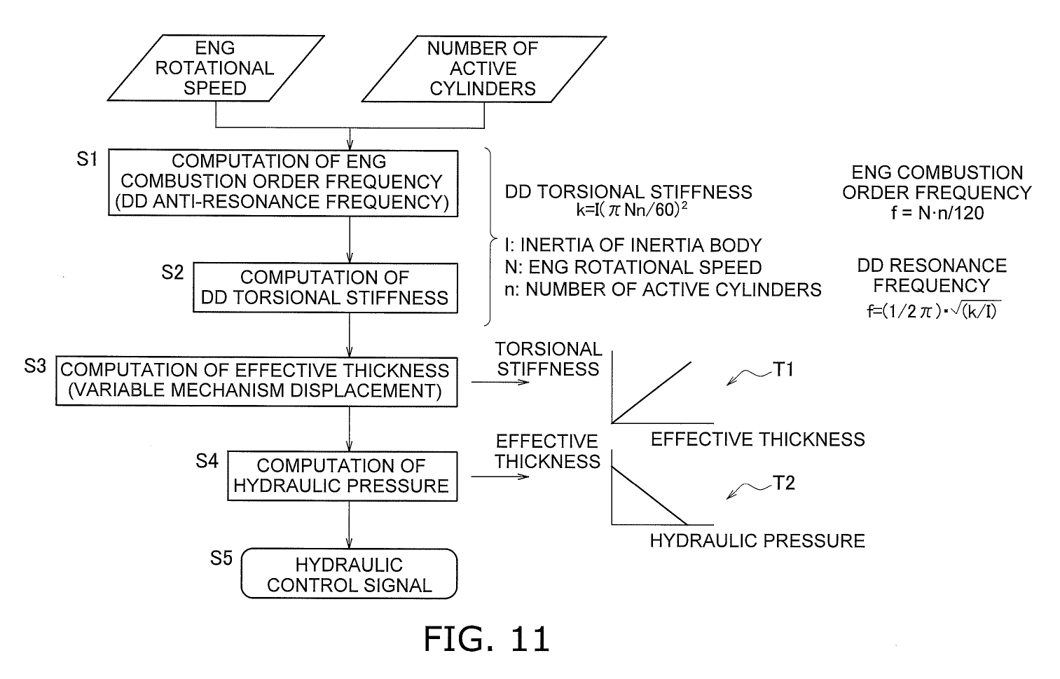

The controller 52 receives, as control parameters, the engine rotational speed inputted from an engine rotational speed sensor 53 and the number of active cylinders inputted from an engine controller 54. Then, by following a flowchart shown in FIG. 11, the controller 52 computes a hydraulic control signal based on the aforementioned control parameters, and outputs the hydraulic control signal to the hydraulic control valve 51. It should be noted that the number of active cylinders refer to the number of cylinders actually activated in all the cylinders of the engine.

First, in steps S1 and S2, engine combustion order frequency and dynamic damper torsional stiffness are computed based on the engine rotational speed and the number of active cylinders. As shown in FIG. 11, the following formulas (1) and (2) are herein given:

Engine combustion order frequency f=N·n/120 (1)

Dynamic damper resonance frequency f=(½π)·(k/I)^{1/2} (2)
where I: the amount of inertia of the inertia member 21
N: the engine rotational speed
n: the number of active cylinders
   Therefore, based on the formulas (1) and (2), torsional stiffness k of the dynamic damper is computed with the following formula:

Dynamic damper torsional stiffness k=I·(π·N·n/60)²

Next in step S3, as shown in FIG. 11, with reference to table T1, effective thickness is computed based on the dynamic damper torsional stiffness k obtained in step S2. The table T1 has been preliminarily obtained and shows a relation between effective thickness and torsional stiffness.

Furthermore in step S4, with reference to table T2, hydraulic pressure is computed based on the effective thickness obtained in step S3. The table T2 has been preliminarily obtained and shows a relation between hydraulic pressure and effective thickness. Then in step S5, a hydraulic control signal is computed. The hydraulic control valve 51 is controlled by the hydraulic control signal.

It should be noted that as shown with dashed two-dotted line in FIG. 10, the effective thickness or displacement in movement attributed to the effective thickness variable mechanism 42 can be configured to be detected and inputted to the controller 52, and the controller 52 can be configured to perform feedback control based on the detection result.

### Application Examples

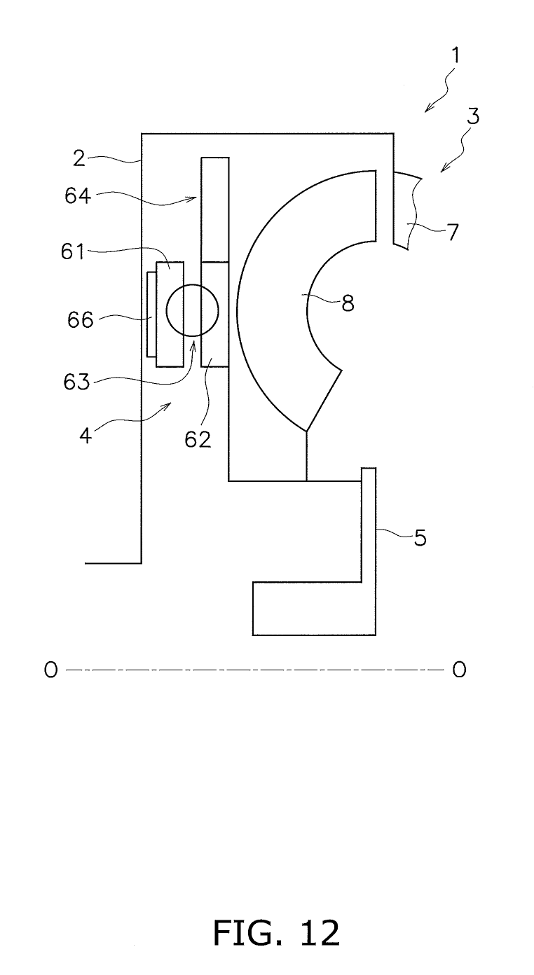

FIG. 12 shows an example that the power transmission device 1 according to the aforementioned preferred embodiments is applied to a torque converter. The torque converter includes a front cover 2, a torque converter body 3, a lock-up device 4 and an output hub 5. A torque is inputted to the front cover 2 from the engine. The torque converter body 3 includes an impeller 7 coupled to the front cover 2, a turbine 8 and a stator (not shown in the drawings). The turbine 8 is coupled to the output hub 5, and the input shaft of the transmission (not shown in the drawings) is capable of being spline-coupled to the inner peripheral part of the output hub 5.

[Lock-Up Device 4]

The lock-up device 4 includes a clutch part, a piston to be actuated by hydraulic pressure, and so forth, and is settable to a lock-up on state and a lock-up off state. In the lock-up on state, the torque inputted to the front cover 2 is transmitted to the output hub 5 through the lock-up device 4 without through the torque converter body 3. On the other hand, in the lock-up off state, the torque inputted to the front cover 2 is transmitted to the output hub 5 through the torque converter body 3.

The lock-up device 4 includes an input-side rotor 61, a hub flange 62, a damper 63 and a dynamic damper device 64.

The input-side rotor 61 includes an axially movable piston, and is provided with a friction member 66 fixed to the front cover 2-side lateral surface thereof. When the friction member 66 is pressed onto the front cover 2, the torque is transmitted from the front cover 2 to the input-side rotor 61.

The hub flange 62 is disposed in axial opposition to the input-side rotor 61 and is rotatable relatively to the input-side rotor 61. The hub flange 62 is coupled to the output hub 5.

The damper 63 is disposed between the input-side rotor 61 and the hub flange 62. The damper 63 includes a plurality of torsion springs and elastically couples the input-side rotor 61 and the hub flange 62 in a rotational direction. The damper 63 transmits the torque from the input-side rotor 61 to the hub flange 62, and also, absorbs and attenuates torque fluctuations.

In the lock-up device 4 configured as described above, the hub flange 62 corresponds to the rotor 10 in the preferred embodiment shown in FIG. 1, whereas the dynamic damper device 64 corresponds to the dynamic damper device 20 in the preferred embodiment shown in FIG. 1.

### Other Preferred Embodiments

The present disclosure is not limited to the preferred embodiments described above, and a variety of changes or modifications can be made without departing from the scope of the present advancement.

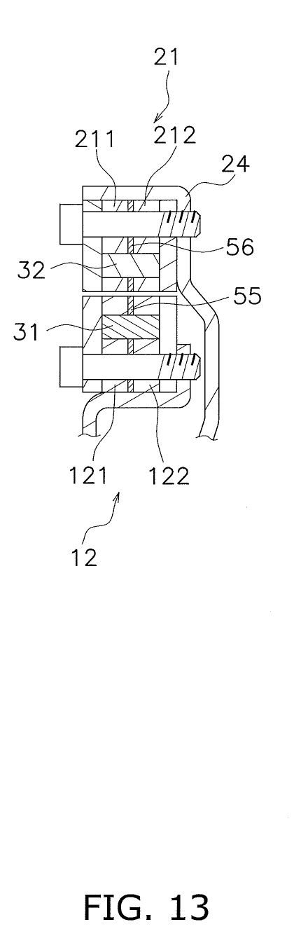

(a) As shown in FIG. 13, at least one of the hub and the inertia member can be axially divided, and the divided parts can be insulated from each other. In the example shown in FIG. 13, the hub 12 is composed of a first divided hub 121 and a second divided hub 122. On the other hand, the inertia member 21 is composed of a first divided inertia member 211 and a second divided inertia member 212. Then, an insulator 55 is provided axially between the first divided hub 121 and the second divided hub 122, whereas an insulator 56 is provided axially between the first divided inertia member 211 and the second divided inertia member 212.

In the example described above, it is possible to reduce eddy current generated in the hub 12 and the inertia member 21. Therefore, it is possible to inhibit heat generation caused by generation of eddy current and inhibit a hysteresis torque appearing in the torsional characteristics.

(b) In the example shown in FIG. 13, the insulators are provided on the boundary surface between the divided parts of the hub and that between the divided parts of the inertia member, respectively. However, the insulators might not be provided. When the insulators are not provided, the hysteresis torque, attributed to the eddy current generated in the hub and the inertia member, can be made relatively large in magnitude. In other words, the dynamic damper device, although requiring a hysteresis torque with a predetermined magnitude in some engine specification or so forth, can be realized with such desired performance when not provided with insulators between the divided parts of the hub and between the divided parts of the inertia member, respectively.

(c) In the modifications shown in from FIG. 6 to FIG. 8, one or both of the magnets can be divided into two magnets. However, examples of the number of the divided magnets and the like are not limited to the aforementioned modifications. For example, one magnet can be divided into two (or three) magnets and the other magnet can be divided into three (or two) magnets.

What is claimed is:

1. A dynamic damper device for inhibiting torque fluctuations in a rotor to which a torque is inputted, the dynamic damper device comprising:
a mass body disposed to be rotatable with the rotor and be rotatable relatively to the rotor; and
a magnetic damper mechanism including at least a pair of magnets disposed in the rotor and the mass body, the magnetic damper mechanism for coupling the rotor and the mass body in a rotational direction by a magnetism of the pair of magnets.

2. The dynamic damper device according to claim 1, wherein the magnetic damper mechanism includes
a plurality of first magnets attached to the rotor, and
a plurality of second magnets attached to the mass body, the plurality of second magnets opposed to the plurality of first magnets.

3. The dynamic damper device according to claim 2, wherein
the mass body has an annular shape, the mass body disposed on an outer peripheral side of the rotor, the mass body opposed at an inner peripheral surface thereof to an outer peripheral surface of the rotor,
the plurality of first magnets are disposed in an outer peripheral part of the rotor, and
the plurality of second magnets are disposed in an inner peripheral part of the mass body.

4. The dynamic damper device according to claim 2, wherein
the plurality of first magnets are disposed in an outer peripheral part of the rotor in a circular alignment,
the plurality of second magnets are disposed in an inner peripheral part of the mass body in a circular alignment, and
the magnetic damper mechanism further includes flux barriers provided circumferentially between two adjacent magnets of the plurality of first magnets and circumferentially between two adjacent magnets of the plurality of second magnets respectively.

5. The dynamic damper device according to claim 2, wherein the plurality of first magnets are disposed such that polarities thereof are aligned circumferentially and alternately, the plurality of second magnets disposed such that polarities thereof are aligned circumferentially and alternately.

6. The dynamic damper device according to claim 1, wherein at least one of the rotor and the mass body is axially divided into at least two parts.

7. The dynamic damper device according to claim 6, wherein the magnetic damper mechanism further includes insulators provided on a boundary surface between divided parts of the rotor and a boundary surface between divided parts of the mass body.

8. The dynamic damper device according to claim 2, wherein at least one of the first and second magnets is divided into at least two parts, the at least two parts opposed to each of the plurality of the other of the second or first magnets.

9. The dynamic damper device according to claim 1, further comprising:
a moving mechanism for axially moving either the rotor or the mass body.

10. The dynamic damper device according to claim 9, wherein
the torque inputted to the rotor is from an engine,
the dynamic damper device further comprising:
a drive mechanism for driving the moving mechanism; and
a moving control part for controlling the drive mechanism in accordance with at least a rotational speed of the engine.

11. The dynamic damper device according to claim 10, wherein
the moving mechanism includes a piston, the piston axially movable together with either the rotor or the mass body,
the drive mechanism is a hydraulic control valve for driving the piston by a hydraulic pressure from a hydraulic source, and
the moving control part outputs a hydraulic control signal to the hydraulic control valve.

12. The dynamic damper device according to claim 1, wherein
the magnetic damper mechanism couples the rotor and the mass body in a rotational direction by the pull force of the pair of magnets.

13. A power transmission device comprising:
a rotor to which a torque is inputted;
a mass body disposed to be rotatable with the rotor and be rotatable relatively to the rotor; and
a magnetic damper mechanism including at least a pair of magnets disposed in the rotor and the mass body, the magnetic damper mechanism for coupling the rotor and the mass body in a rotational direction by the magnetism of the pair of magnets.
